(19) United States
(12) Patent Application Publication
(10) Pub. No.: US 2009/0173183 A1
(43) Pub. Date: Jul. 9, 2009

(54) Flywheel with stuffing material

(76) Inventor: Chao-Chuan Chen, Taichung (TW)

Correspondence Address: PHILLIP LIU, 6980, WHITEOAK DR., RICHMOND, BC, V7EAZ9, CA

(21) Appl. No.: 12/007,058

(22) Filed: Jan. 7, 2008

(51) Int. Cl. F16F 15/30

(52) U.S. Cl. 74/572.21

(57) ABSTRACT

A flywheel of a stationary bike includes a rim and a hub is located at a center of the rim, a plurality of ribs are connected between the rim and the hub. Stuffing material such as concrete or sands combined with adhesive is refilled with space between the rim, the hub and the ribs. Two cover plates are connected on two sides of the flywheel so as to cover the stuffing material.

### FIELD OF THE INVENTION

The present invention relates to a flywheel for stationary bike and the flywheel includes stuffing material filled with spaces between the rim and the ribs.

### BACKGROUND OF THE INVENTION

A conventional stationary bike generally includes a base with a seat tube and a seat is connected on a top of the seat tube. A post extends from the base and a handlebar is connected to the post, a control panel is connected to the handlebar. A driving wheel is connected to the bike and includes a crank so that the user treads the pedals on the crank to rotate the driving wheel. A flywheel is located behind the driving wheel and is supported on two support frames and a belt is connected between the driving wheel and the shaft of the flywheel so that the user has to apply a sufficient force to rotate the flywheel. The flywheel generates a significant resistance to exercise the users.

Generally, the flywheel is made by metal which is heavy and composed of a rim, a hub and ribs connected between the rim and the hub. In order to obtain a heavy flywheel, significant amount of metal is required and the metal increases the cost of the flywheel.

The present invention intends to provide a flywheel of a stationary bike and the flywheel needs only limited metal and stuffing material is used to fill the space between the rim and the ribs so that the flywheel can be made to be heavy enough at low cost.

### SUMMARY OF THE INVENTION

The present invention relates to a flywheel for a stationary bike and the flywheel includes a rim with a hub located at a center of the rim, and a plurality of ribs are connected between the rim and the hub. Stuffing material is filled with space between the rim, the hub and the ribs. The stuffing material can be concrete or sands combined with adhesive so as to increase the weight of the flywheel at low cost.

The primary object of the present invention is to provide a flywheel of a stationary bike and the flywheel includes a metal rim, a hub and ribs connected between the hub and ribs. Stuffing material is filled with space between the rim, the hub and the ribs.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the metal part of the flywheel of the present invention;

FIG. 2 is a cross sectional view, taken along line A-B in FIG. 1, of the metal part of the flywheel of the present invention;

FIG. 3 is an exploded view to show that stuffing material is filled with the space between the ribs of the flywheel, and two cover plates;

FIG. 4 is a cross sectional view of the flywheel in FIG. 3;

FIG. 5 is a perspective view to show the flywheel installed on a stationary bike of the present invention, and

FIG. 6 is a side view of the stationary bike with the flywheel of the present invention.

### DETAILED DESCRIPTION OF THE PREFERRED EMBODIMENT

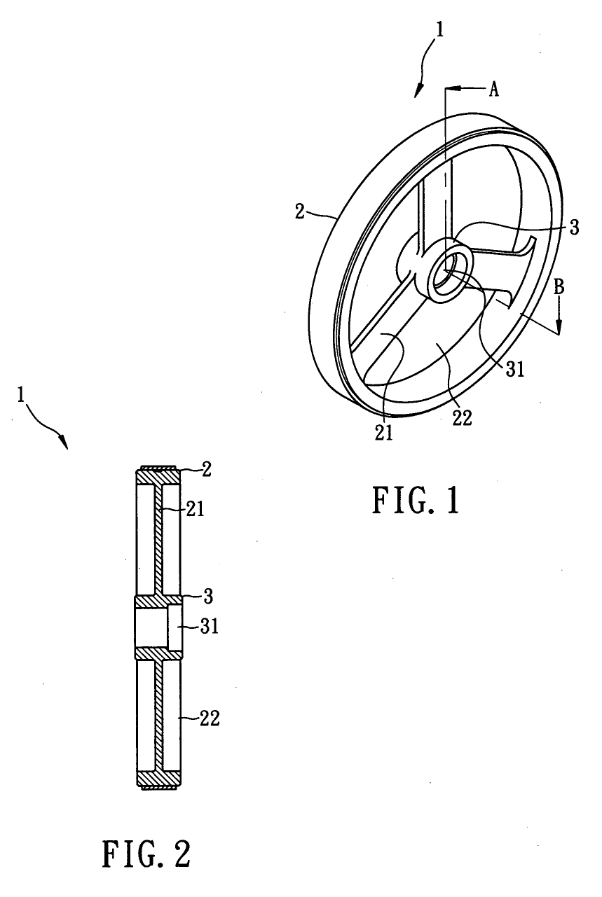

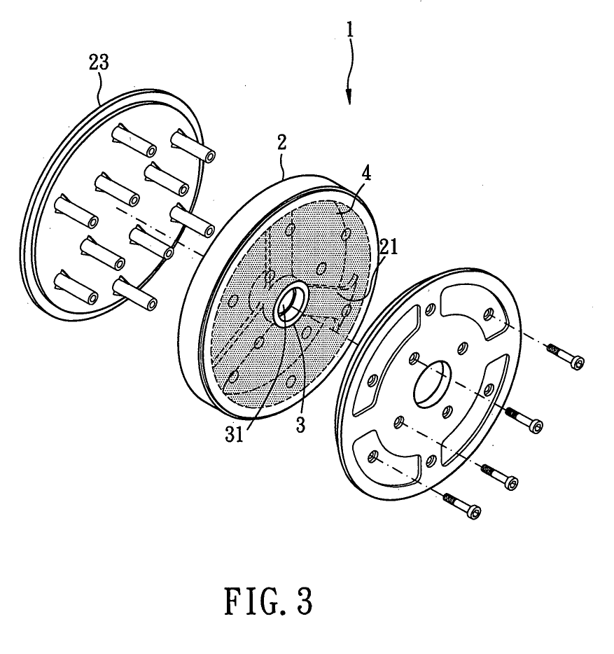

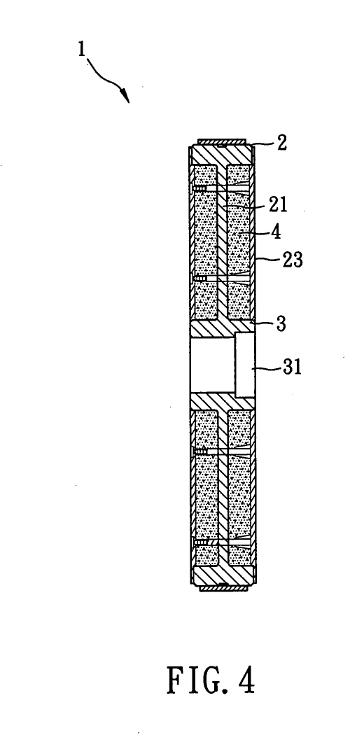

Referring to FIGS. 1 to 4, the flywheel 1 of a stationary bike of the present invention comprises a round rim 2 and a hub 3 located at a center of the rim 2, three ribs 21 connected between the rim 2 and the hub 3. The rim 2, the hub 3 and the ribs 21 are integrally connected to each other and made by metal, two ends of the hub 3 are protruded out from two sides of the rim 2 as shown in FIG. 2. The hub 3 includes a passage 31 defined axially therethrough and the passage 31 includes a first diameter and a second diameter which is smaller than the first diameter. A shaft extends through the passage 31 and a bearing is engaged with the space of the first diameter. Stuffing material 4 is filled with space 22 between the rim 2, the hub 3 and the ribs 21.

The stuffing material 4 can be concrete or sands and adhesive. The stuffing material 4 encloses the ribs 21 and increases the weight of the flywheel 1 at low cost.

Two cover plates 32 are connected on two sides of the flywheel to cover the stuffing material 4. One of the two cover plates 32 includes tubes extending from an inside thereof and the tubes extend through the stuffing material 4, a plurality of bolts extend through holes defined through the other cover plate 23 and are connected to the tubes.

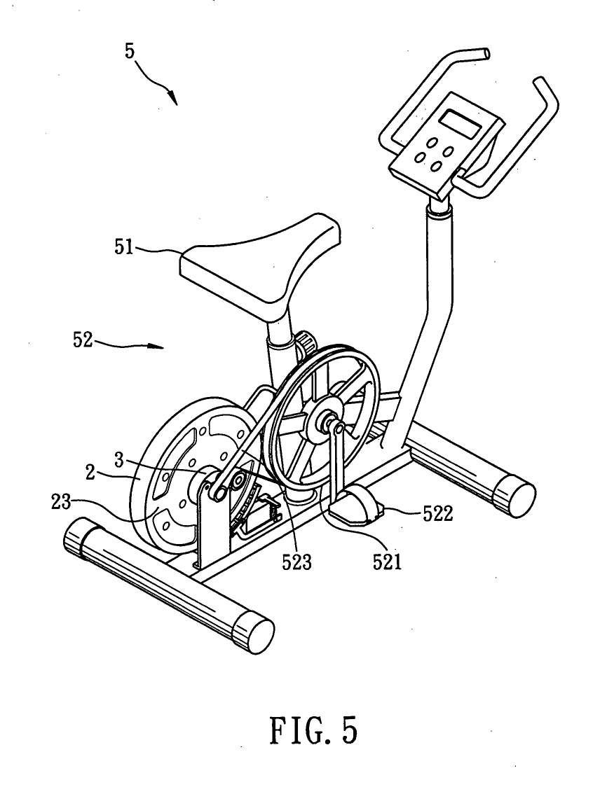

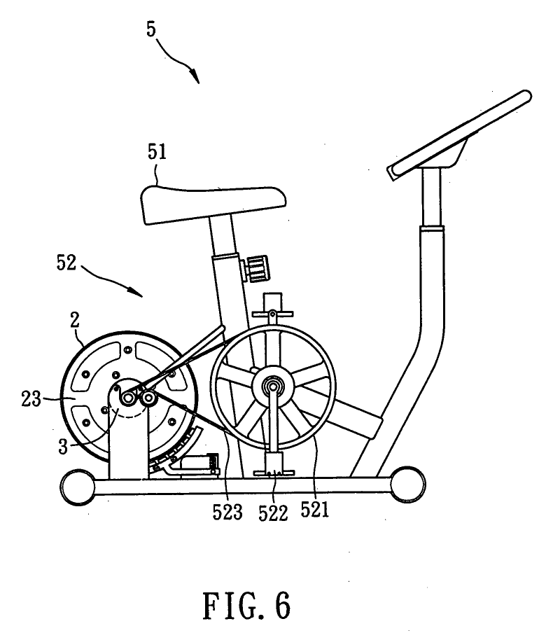

As shown in FIGS. 5 and 6, the stationary bike 5 includes an H-shaped base and a driving mechanism 52 is connected to the base. A seat 51 is connected on the seat tube extending from the base and a driving wheel 521 is connected to the link connected between the seat tube and the post on which a handlebar and a control panel are connected. A crank is connected to the driving wheel 521 and two pedals 522 are connected on two ends of the crank. The flywheel 1 is supported by two frames and located behind the driving wheel 521. A belt 523 is connected between the driving wheel 521 and the shaft of the flywheel 1. A resistance unit is located on the base and faces the rim 2 of the flywheel 1. When the user operates the crank to rotate the driving wheel 521, the flywheel 1 is driven via the belt 523. The flywheel 1 is heavy so that the user has to apply force to rotate it and the flywheel 1 is made at low cost.

While we have shown and described the embodiment in accordance with the present invention, it should be clear to those skilled in the art that further embodiments may be made without departing from the scope of the present invention.

What is claimed is:

1. A flywheel comprising:
a rim and a hub located at a center of the rim, a plurality of ribs connected between the rim and the hub, and
stuffing material filled with space between the rim, the hub and the ribs.

2. The flywheel as claimed in claim 1, wherein the stuffing material is concrete and adhesive.

3. The flywheel as claimed in claim 1, wherein the stuffing material is sands and adhesive.

4. The flywheel as claimed in claim 1, wherein the rim, the hub and the ribs are integrally connected to each other.

5. The flywheel as claimed in claim 1, wherein the rim is a round rim.

6. The flywheel as claimed in claim 1, wherein the hub includes a passage defined axially therethrough and the passage includes a first diameter and a second diameter which is smaller than the first diameter.

7. The flywheel as claimed in claim 1, wherein two cover plates connected on two sides of the flywheel to cover the stuffing material.

8. The flywheel as claimed in claim 7, wherein one of the two cover plates includes tubes extending from an inside thereof and the tubes extend through the stuffing material, a plurality of bolts extend through holes defined through the other cover plate and are connected to the tubes.
